(19) United States
(12) Patent Application Publication
(10) Pub. No.: US 2023/0123627 A1
(43) Pub. Date: Apr. 20, 2023

(54) DEVICE FOR CONVERTING BIOMASS TO REDUCED MEDIATOR, SYSTEM FOR CONVERTING BIOMASS TO DIHYDROGEN COMPRISING IT, AND ASSOCIATED METHOD

(71) Applicants: UNIVERSITE GRENOBLE ALPES, Saint Martin D'Heres (FR); CENTRE NATIONAL DE LA RECHERCHE SCIENTIFIQUE, Paris (FR); INSTITUT POLYTECHNIQUE DE GRENOBLE, Grenoble (FR); UNIVERSITE SAVOIE MONT BLANC, Chambery (FR)

(72) Inventors: Pierre BELLEVILLE, Montbonnot (FR); Jonathan DESEURE, Challes Les Eaux (FR); Gérard MERLIN, Lescheraines (FR)

(21) Appl. No.: 17/915,537

(22) PCT Filed: Mar. 30, 2021
(86) PCT No.: PCT/EP2021/058282

§ 371 Date: Sep. 29, 2022

(30) Foreign Application Priority Data
Mar. 31, 2020 (FR) FR2003204

(51) Int. Cl. C02F 3/00; C02F 3/34; C02F 3/10; H01M 16/00

(52) U.S. Cl. CPC C02F 3/005; C02F 3/34; C02F 3/102; H01M 16/003; C02F 2303/10; C02F 2203/006; C02F 2209/06; C02F 2209/02

(57) ABSTRACT

A device for converting biomass into a redox mediator in reduced form, including an assembly of microbial fuel cells including a first compartment including an anode and fermentative microorganisms and electroactive microorganisms, and a second compartment including a cathode and a solution including the mediator, and an external resistor connecting the cathode and the anode. The value of the external resistance of at least one microbial fuel cell is distinct from that of at least one other microbial fuel cell. The device thus makes it possible to induce segregation of fermentative microorganisms and electroactive microorganisms along the assembly.

### TECHNICAL FIELD

The present invention relates to the field of the biological treatment of effluents such as wastewater or sludge. It finds a particularly advantageous application in the field of hydrogen production by the biological treatment of these effluents.

### STATE OF THE ART

The collection and treatment of effluents, and more specifically of wastewater, involve a significant consumption of energy. In addition, their energy potential is currently largely under-valued. The share of energy consumption in the United States is now estimated at 3% for the treatment of wastewater purification station effluents. In particular, the processes of aeration of basins, for the degradation by oxidation of biomass, involve a significant energy cost without making use of the energy potential of the biomass.

A typical energy recovery route for biomass from wastewater is anaerobic digestion. However, anaerobic digestion is limited to the anaerobic digestion of sludge and anaerobic treatment of industrial effluents with high organic load rates, otherwise the investment associated with the anaerobic digestion units is no longer profitable. In addition, anaerobic digestion requires a long residence time of the effluents in the anaerobic digestion units, for example more than two weeks, and requires coupling with an aerobic treatment to finalise the water purification.

Electrochemical systems coupled to microorganisms have emerged for the energy recovery of wastewater. These systems generally include electroactive biofilms. It is known on the one hand microbial fuel cells comprising an air cathode for the production of electricity. On the other hand, it is known microbial electrolysers for the production of hydrogen. However, these systems are limited by the low current densities that can pass through the electroactive biofilms. Their performance and their prospects for industrialisation therefore remain limited.

It is known from the document P. Belleville, et al., Low voltage water electrolysis: Decoupling hydrogen production using bioelectrochemical system, International Journal of Hydrogen Energy, 43 (32), 2018, p. 14867-14875, a system comprising a bioelectrochemical reactor comprising an assembly of microbial fuel cells, configured to oxidise biomass from wastewater and produce a mediator in its reduced form. The system further includes an electrolyser configured to oxidise the reduced mediator and thereby induce production of the hydrogen. However, the conversion of biomass by this system can still be optimised.

An object of the present invention is therefore to provide a device making it possible to optimise the conversion of biomass into a reduced mediator.

The other objects, features and advantages of the present invention will become apparent on examination of the following description and the accompanying drawings. It is understood that other advantages can be incorporated.

### SUMMARY

To achieve this objective, according to one embodiment there is provided a device for converting biomass into a redox mediator agent in reduced form, comprising an assembly of several microbial fuel cells connected in series by a fluidic flow line, each microbial fuel cell comprising:
a first compartment comprising an anode and at least one of fermentative microorganisms and electroactive microorganisms, and
a second compartment comprising a cathode and a solution comprising the redox mediator agent, the first compartment and the second compartment being separated by a semi-permeable membrane, and
an external resistor connecting the cathode and the anode.

Advantageously, the value of the external resistance of at least one of said two microbial fuel cells is distinct from the value of the external resistance of the other of said two microbial fuel cells, so as to favour, in at least one of said two microbial fuel cells, the fermentative microorganisms relative to the electroactive microorganisms and, in the other of said at least two microbial fuel cells, the electroactive microorganisms relative to the fermentative microorganisms.

Thus, the assembly of microbial fuel cells forms a bioelectrochemical reactor allowing the conversion of biomass, for example from wastewater, into the mediator in its reduced form. This conversion involves successive metabolic reactions by syntrophy between fermentative microorganisms and electroactive microorganisms. The assembly of microbial cells in series and an associated variation in external resistance along the assembly induces segregation of fermentative microorganisms and electroactive microorganisms along the assembly. Spatial segregation of the metabolic reactions involved in the conversion of biomass is therefore obtained along the assembly. This segregation of metabolic reactions maximises their yield and improves syntrophy between fermentative microorganisms and electroactive microorganisms.

Compared to existing solutions, the conversion device maximises the treatment of effluent biomass, and its energy recovery in the form of a reduced redox mediator. The device enables the energy recovery of effluents with an organic load that is too low for anaerobic digestion units. The device can also be associated with anaerobic digestion units to complete them. In addition, because the external resistance is spatially varied along the assembly, the conversion device maximises the processing of the biomass while being able to operate continuously.

A second aspect relates to a system for converting biomass into dihydrogen comprising:
a device for converting biomass into a redox mediator agent in a reduced form, according to the first aspect of the invention, and
an electrolyser configured to produce hydrogen from the mediator in reduced form.

The electrolyser is therefore designed ad hoc to the chosen mediator.

Thus, the production of dihydrogen is decoupled from the conversion of biomass, the mediator acting as an energy carrier for the production of dihydrogen. The energy efficiency of dihydrogen production is increased while reducing its production cost.

A third aspect relates to a biomass conversion method comprising:
a supply of biomass to a device for converting biomass into a redox mediator in reduced form, comprising an assembly of several microbial fuel cells connected in series by a fluidic flow line, at least two microbial fuel cells each comprising:
   a first compartment comprising an anode, fermentative microorganisms and electroactive microorganisms, and
   a second compartment comprising a cathode and a solution comprising an oxidation-reduction mediator, the first compartment and the second compartment being separated by a semi-permeable membrane, and
   an external resistance connecting the cathode and the anode, and
adjusting the value of the external resistance of at least one of said two microbial fuel cells so that the value of said external resistance is distinct from the value of the external resistance of the other of said at least two microbial fuel cells, and
conversion of biomass at least into organic acids by fermentative microorganisms, and
a reduction of the mediator from an oxidised form to a reduced form induced from organic acids by electroactive microorganisms,
   so as to favour, in at least one of said two microbial fuel cells, the fermentative microorganisms relative to the electroactive microorganisms and, in the other of said at least two microbial fuel cells, the electroactive microorganisms relative to the fermentative microorganisms.

Thus, the method achieves spatial variation of the external resistance in the microbial fuel cell assembly of the converter device, and thus induces segregation of fermentative microorganisms and electroactive microorganisms along the assembly.

Compared to existing solutions, the conversion method optimises the treatment of biomass and its energy recovery. The method makes it possible to reduce the cost of treating biomass, compared to solutions using turbines or by injecting air.

In addition, the method can be carried out on a continuous basis, by converting the biomass along the assembly.

### BRIEF DESCRIPTION OF THE FIGURES

The aims, objects, as well as the features and advantages of the invention will become more apparent from the detailed description of an embodiment thereof which is illustrated by the following accompanying drawings in which:

FIG. 1 represents a schematic view of a system for converting biomass into hydrogen according to one embodiment of the invention.

FIG. 2 represents a schematic view of a microbial fuel cell according to one embodiment of the invention.

FIG. 3 represents a schematic view of a microbial fuel cell assembly, illustrated in FIG. 2.

FIG. 4 represents a schematic view of a device for converting biomass into a mediator in its reduced form, comprising several assemblies of microbial fuel cells, illustrated in FIG. 2.

FIG. 5 is a current/voltage curve graph, also called curves IV, of the release of dihydrogen into a pH 7 buffered mediator medium by a 0.5 M dihydrogen phosphate solution; each curve being associated with a metal constituting the cathode of the electrolyser different from the other curves.

The drawings are given by way of example and are not limiting of the invention. They constitute schematic representations of principle intended to facilitate understanding of the invention and are not necessarily on the scale of practical applications. In particular, the relative dimensions of the components of the conversion device and/or of the conversion system are not representative of reality.

### DETAILED DESCRIPTION

Before starting a detailed review of embodiments of the invention, the following are optional features of the first aspect of the invention which can optionally be used in combination or alternatively:
the assembly of microbial fuel cells comprises fermentative microorganisms and electroactive microorganisms, their relative proportions varying between at least two distinct microbial fuel cells,
at least one of fermentative microorganisms and electroactive microorganisms is included in a biofilm, for example for each microbial fuel cell,
the value of the external resistance of a first microbial fuel cell of the assembly is less than or equal to the value of the external resistance of a second microbial fuel cell of the same assembly, the first microbial fuel cell being located before the second microbial fuel cell in a direction of flow of a fluid in the flow line,
the value of the external resistance between at least part of the microbial fuel cells of the assembly, or even between all of the microbial fuel cells of the assembly, decreases in a direction of flow of a fluid in the flow line,
the assembly comprises a first group of microbial fuel cells and a second group of microbial fuel cells following one another in a direction of flow of a fluid in the flow line,
the value of the external resistance of at least one microbial fuel cell of the first group is between 0.8Rᵢₙₜ<Rₑₓₜ<1.5 Rᵢₙₜ,
the value of the external resistance of at least one microbial fuel cell of the first group is greater than the value of the internal resistance of said cell,
the value of the external resistance Rₑₓₜ of at least one microbial fuel cell of the second group is between Rᵢₙₜ/10<Rₑₓₜ<4Rᵢₙₜ/5, with Rᵢₙₜ the value of the internal resistance of said cell. According to one example, the value of the external resistance Rₑₓₜ of at least one microbial fuel cell of the second group is between Rᵢₙₜ/10<Rₑₓₜ<4Rᵢₙₜ/5, and the biomass in transit in said at least a microbial fuel cell has an acetate concentration greater than 5 mM,
the mediator exhibits a redox potential which is substantially independent of the variations in concentration of the mediator between an oxidised form and a reduced form. The redox potential of the mediator can more specifically be within a range of +/−20%, preferably +/−10%, around its value under standard conditions at pH=7 and at a temperature of 25° C. For example, the oxidation-reduction potential of the mediator is between 410 mV and 450 mV relative to the Normal Hydrogen Electrode (abbreviated NHE) under standard conditions at pH 7 and at a temperature of 25° C.,
the mediator is a hexacyanoferrate complex, preferably buffered at pH 7 by a dihydrogen phosphate solution at a molar concentration of between 0.2 and 2 M, for example substantially equal to 0.5 M (or 0.5 mol/L in units of SI),
preferably, the redox mediator exhibits, at least in the second compartment of the last microbial fuel cell of the assembly, a stable electrochemical torque in a wide range of proportion between its reduced and oxidised forms. More specifically, the redox potential of the mediator can be in a range of +/−20%, preferably of +/−10%, around its value under standard conditions at pH=7 and at a temperature of 25° C.,
the assembly comprises at least three microbial fuel cells connected in series,
the device comprises several assemblies connected in parallel by the fluidic flow line,
the device comprises in all at least ten, even at least twenty, microbial fuel cells,
at least one of fermentative microorganisms and electroactive microorganisms is obtained from a sample of wastewater purification station effluent,
the semi-permeable membrane is a cationic semi-permeable membrane.

Optional features of the second aspect of the invention are set out below, which can optionally be used in combination or alternatively:
the electrolyser is connected by a fluid line connecting the conversion device;
the fluidic connection line is configured to conduct, through a first portion, the mediator from the conversion device to the electrolyser, and to conduct, through a second portion, the mediator from the electrolyser to the conversion device, the first portion being distinct from the second portion;
the electrolyser is free from fermentative microorganisms and electroactive microorganisms;
preferably, the redox mediator circulating between the second compartment of the last microbial fuel cell of the assembly and the electrolyser exhibits a stable electrochemical torque in a wide range of proportion between its reduced and oxidised forms. More specifically, the redox potential of the mediator can be in a range of +/−20%, preferably of +/−10%, around its value under standard conditions at pH=7 and at a temperature of 25° C. In this case, the electrolyser can have no semi-permeable membrane, which is advantageous in terms of cost. For example, it is advantageously possible that the mediator is a hexacyanoferrate complex, preferably buffered at pH equal to 7, in particular by a dihydrogen phosphate solution at a molar concentration of between 0.2 and 2 M, for example substantially equal to 0.5 M (or 0.5 mol/L in units of SI);
the cathode of the electrolyser has a basis, even constituted, of austenitic stainless steel-type materials. These materials have the advantage of being commercial;
the anode of the electrolyser has a basis, even constituted, of at least materials from among:
   nickel-rich alloys,
   pure nickel,
   noble DSA® (“Dimensionally Stable Anode”)-type materials, and
   a material known and used as a gaseous diffusion layer (or GDL) in the field of fuel cells (or PEM), and optionally functionalised by a catalytic deposition, for example, a platinum deposition. These materials have the advantage of being commercial;
a deviation distance between the anode and the cathode of the electrolyser is greater than 2 mm, and for example substantially equal to 4, 8 or 10 mm. When this feature is combined with the addition of a buffer to maintain the mediator at a pH equal to 7, typically by adding a dihydrogen phosphate solution, it is advantageously permitted to double the faradic yield of the electrolyser; and
the anode of the electrolyser is preferably of an active surface at least equal to double, preferably triple, an active surface of the cathode. When this feature is combined with the addition of a buffer to maintain the mediator at a pH equal to 7 and at a deviation distance between the anode and the cathode of the electrolyser greater than 2 mm, it is advantageously permitted to improve the yield or the coulombic efficiency of the system according to the second aspect of the invention.

Optional features of the third aspect of the invention are set out below, which can optionally be used in combination or alternatively:
the value of the external resistance of at least one microbial fuel cell is adjusted as a function of the load of the biomass, in particular in the effluent,
the value of the external resistance of at least one microbial fuel cell is adjusted as a function of the chemical oxygen demand of the biomass, in particular in the effluent,
the value of the external resistance of at least one microbial fuel cell is adjusted so as to be between Rᵢₙₜ/10<Rₑₓₜ<4 Rᵢₙₜ/5 when an acetate concentration measured at the input of said fuel cell microbial is greater than 5 mM, with Rᵢₙₜ the value of the internal resistance of said cell, the method comprising prior to said adjustment a measurement of the concentration of acetate at the inlet of said microbial fuel cell,
the adjustment of the value of the external resistance of at least one microbial fuel cell is carried out at regular intervals, for example weekly or even daily,
the method further comprises supplying the mediator in reduced form to an electrolyser,
the method further comprises a production of dihydrogen by the electrolyser from the mediator in reduced form.

It is specified that in the context of the present invention, the term biomass generally designates organic material of human, plant, animal, bacterial or fungal origin.

The term “chemical oxygen demand”, abbreviated COD, of the biomass is understood to mean the concentration of oxidizable compounds present in the biomass, such as, for example, fermentable sugars.

The term “load” of the biomass is understood to mean the daily volume load, i.e. a quantity corresponding to the COD per volume passing through the device, over a day. The load can be determined by Q×[COD]/V, with Q the flow rate of the biomass and V its volume, or by τ×[COD], with τ the hydraulic retention time in the device, and more specifically in I assembly of microbial fuel cells.

In general and in the scope of the present invention, the term “redox mediator” is understood to mean a compound receiving at least one electron from another chemical compound, for example an electrode, during a reduction reaction, to go from an oxidised form to a reduced form, and giving up at least one electron to another chemical compound, for example an electrode, during an oxidation reaction, to go from a reduced form to an oxidised form.

The term “semi-permeable” describes a membrane which allows certain compounds in solution to pass through both sides of this membrane and which opposes the passage of other compounds in the same solution. For example, a semi-permeable membrane can be configured to let pass on either side of this membrane, molecules of a size less than a threshold size, while the passage of molecules of a size greater than this size is blocked. As an alternative or in addition, a semi-permeable membrane can be configured to allow only certain loaded species to pass. For example, a cationic semipermeable membrane only allows cations to pass by blocking anions.

By “active surface of an electrode”, this means the portion of the contact surface of at least one electrolyte and an electrode on which an electrode reaction occurs.

By a parameter “substantially equal/greater/less than” a given value is meant that this parameter is equal/greater/less than the given value, to within plus or minus 10%, or even to within plus or minus 5%, of this value.

In the detailed description which follows, use may be made of terms such as “previous”, “next”, “before”, “rear”, “upstream”, “downstream”. These terms are to be interpreted relatively in relation to the normal direction of flow of a fluid in the converter device and/or the converter system. For example, when a first element is located “upstream” of a second element, the first element is disposed closer to a point of origin of the flow of a fluid than the second element. On the contrary, when a first element is located “downstream” of a second element, the first element is disposed further from the point of origin of the fluid flow than the second element.

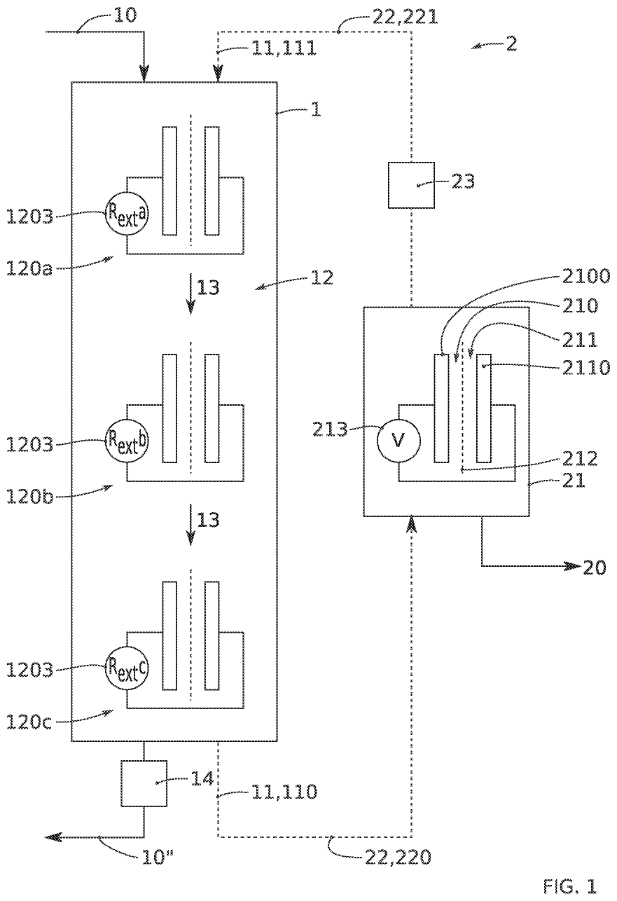

The system 2 for converting biomass 10 is now described with reference to FIG. 1. The system 2 is configured to convert biomass 10 to dihydrogen 20. The biomass 10 can be included in an effluent. For example, the effluent is wastewater, i.e. water that has been used for domestic, agricultural or industrial use. Below in the description, it is considered without limitation that the biomass 10 is included in a wastewater effluent.

The system 2 comprises a device 1 for converting the biomass 10 into a redox mediator 11 in its reduced form 110. The device 1 is configured to degrade the biomass 10 and thus treat the effluent. In order to degrade the biomass 10, the device is more specifically configured to reduce the organic load of the biomass 10, hereinafter referred to as the biomass load, during the flow of the effluent in the device 1. The device 1 is further configured to create a reserve of chemical energy by the reduction of the mediator 11. This energy reserve can then be utilized by an electrolyser 21 configured to generate dihydrogen from the mediator 11 in its reduced form 110. The device 1 and the system 2 make it possible to enhance the energy power of the biomass of an effluent.

The general operation of the system 2 can be as follows, described with reference to FIG. 1. The conversion device 1 comprises at least one assembly 12 of several microbial fuel cells 120, hereinafter abbreviated as PCM. These PCMs are connected in series by a fluidic flow line 13. This line 13 thus comprises portions each serving to fluidly connect two adjacent PCMs 120. The biomass 10 can be supplied to device 1. The fluidic flow line 13 can drive the flow of biomass 10 along the assembly 12. PCMs are configured to, along the assembly 12, degrade the biomass 10 and induce the reduction of the mediator 11. Thus, an effluent comprising the biomass 10 can be treated as it flows into the device 1 to recover an effluent 10″ with a load lower than its initial load. The biomass 10 can be continuously supplied to the device 1 and flow along assembly 12 through fluid flow line 13.

The system 2 comprises an electrolyser 21 configured to oxidise the mediator 11 from its reduced form 110 to its oxidised form 111. This oxidation reaction can be coupled with the reduction of hydrogen ions, or equally protons, of formula H⁺, to induce production of dihydrogen 20.

To produce dihydrogen 20 from the mediator 11 in its reduced form 110, the electrolyser 21 can comprise a first compartment 210 comprising an anode 2100 and a solution configured to enable oxidation of the mediator 11. The electrolyser can comprise a second compartment 211 comprising a cathode 2110 and a solution configured to enable the reduction of hydrogen ions. The first compartment 210 and the second compartment 211 can be separated so as to avoid the mixture of their respective solutions, while ensuring an ionic conductivity between the compartments 210, 211. For example, the first compartment 210 and the second compartment 211 can be separated by a semi-permeable membrane 212. The semi-permeable membrane 212 can more specifically be a cationic membrane, allowing cations to pass, and blocking anions.

Alternatively, to produce dihydrogen 20 from the mediator 11 in its reduced form 110, the electrolyser 21 can comprise a first compartment 210 comprising an anode 2100 and a solution configured to enable the oxidation of the mediator 11 and a second compartment 211 comprising a cathode 2110 and a solution configured to enable the reduction of hydrogen ions, the anode 2100 exhibiting an active surface at least twice, even three times, greater than an active surface of the cathode 2110. In this case, the electrolyser 21 can advantageously have no semi-permeable membrane 212 between the first and second compartments 210 and 211. Thus, the solution enabling the oxidation of the mediator 11 is the same as that enabling the reduction of hydrogen ions. If the electrolyser 21 has no semi-permeable membrane 212 between the first and second compartments 210 and 211, it is preferable that:
a deviation distance between the anode 2100 and the cathode 2110, this distance being called ‘entrode’, that is greater than 2 mm, and for example equal to 4, 8 or 10 mm, and/or that
the redox mediator 11 circulating between the second compartment 1201 of the last microbial fuel cell 120c of the assembly 12 and the electrolyser 21 exhibits a stable electrochemical torque in a wide range of proportions between its reduced and oxidised forms. More specifically, the redox potential of the mediator 11 can be in a range of +/−20%, preferably of +/−10%, around its value under standard conditions at pH=7 and at a temperature of 25° C., and/or that
the mediator 11 is a hexacyanoferrate complex, preferably buffered at pH 7 by a dihydrogen phosphate solution at a molar concentration of between 0.2 and 2 M, for example substantially equal to 0.5 M (or 0.5 mol/L in units of SI).

The electrolyser 21 can further comprise a generator 213 enabling to impose the circulation of an electric current between the anode 2100 and the cathode 2110. Preferably, the generator 213 imposes a voltage between the anode 2100 and the cathode 2110. This voltage is preferably greater than or equal to the absolute value of the difference between the redox potential of the mediator 11 between its oxidised form 111 and its reduced form 110 and the redox potential of the H⁺/H₂ pair. This voltage is, for example, substantially equal to 1.5 V.

The following table shows the coulombic efficiency according to the presence or not of a phosphate buffer and of the surface ratio between the anode and the cathode (measurements taken at 1.5 V of voltage difference between the anode and the cathode of the electrolyser):

| GDL-PEM | Coulombic efficiency | Coulombic efficiency |
|---|---|---|
| anode/nickel cathode | without phosphate | with phosphate |
| surface ratio | buffer | buffer 0.5M |
| 3 | 59.7% | 87.9% |
| 2 | 42.9% | 78.3% |
| 1 | 22.0% | 42.9% |

Thanks to the voltage imposed between the anode 2100 and the cathode 2110, the oxidation of the mediator 11 in the first compartment 210 can be induced according to the following reaction.

Med_{red}→Medₒₓ+n e⁻

With Med_{red} meaning the mediator 11 in its reduced form 110, Medₒₓ, meaning the mediator 11 in its oxidised form 111 and n, an integer greater than or equal to 1.

Thanks to the voltage imposed between the anode 2100 and the cathode 2110, the reduction of protons in the second compartment 211 can be induced according to the following reaction.

2H⁺+2e⁻→H_{2(g)}

The overall redox reaction can thus occur in the electrolyser according to the following reaction, according to an example where the oxidation of the mediator 11 brings an electron into play.

2Med_{red}+2H⁺→2Medₒₓ+H_{2(g)}

The use of a mediator 11 can enable to avoid a dioxygen production occurring during an electrolysis of the water. Thus, the risk of explosion linked to a reaction between dioxygen and dihydrogen is minimised, even avoided. The addition of a module configured to separate these gases prior to their reaction is not necessary.

According to an example, the electrolyser 21 has no microorganisms. Thus, the electrolyser does not bring any metabolic reaction into play, enabling the production of dihydrogen 20. The density of current circulating in the electrolyser is thus not limited by microorganisms. The production of dihydrogen at the electrolyser is thus optimised, which offers a viable way of enhancing an effluent for the production of hydrogen at a low cost.

The device 1 can be uncoupled from the electrolyser 21. The device 1 can more specifically be electrically independent from the electrolyser 21. Thus, the electric operating parameters applied to the electrolyser 21 can be distinct from the electric parameters applied to the device 1. These electric parameters can, for example, be the voltage and the current density. Contrary to the solutions, wherein an electrolyser is electrically coupled to a PCM, the conversion system 2 enables to independently adjust the electric parameters of the device 1 and the electric parameters of the electrolyser 21. The electric parameters of one from among the device 1 and the electrolyser 21 can thus not limit the operation of the other. The conversion of the biomass 10 to the mediator 11 in its reduced form 110, and the production of dihydrogen 20 from the mediator 11 in its reduced form 110, can thus be independently optimised.

The device 1 can be connected to the electrolyser 21 by a fluidic connecting line 22, configured to drive the mediator 11 in its reduced form 110 at least the device 1 to the electrolyser 21. Preferably, and as illustrated by FIG. 1, the fluidic connecting line 22 can comprise a first portion 220 configured to drive the mediator 11 in its reduced form 110 of the device 1 to the electrolyser 21. The fluidic connecting line 22 can further comprise a second portion 221 configured to drive the mediator 11 in its oxidised form 111 of the electrolyser 21 to the device 1. The fluidic connecting line 22, a part of the device 1 and a part of the electrolyser 21 can be configured to form a closed circuit for the flow of a solution comprising the mediator 11. Thus, the mediator 11 can circulate continuously in the system 2. The system 1 can thus produce dihydrogen continuously. In order to maintain a circulation of the solution comprising the mediator 11, the system can comprise a pump 23, for example a peristaltic pump, disposed for example on the fluidic connecting line 22.

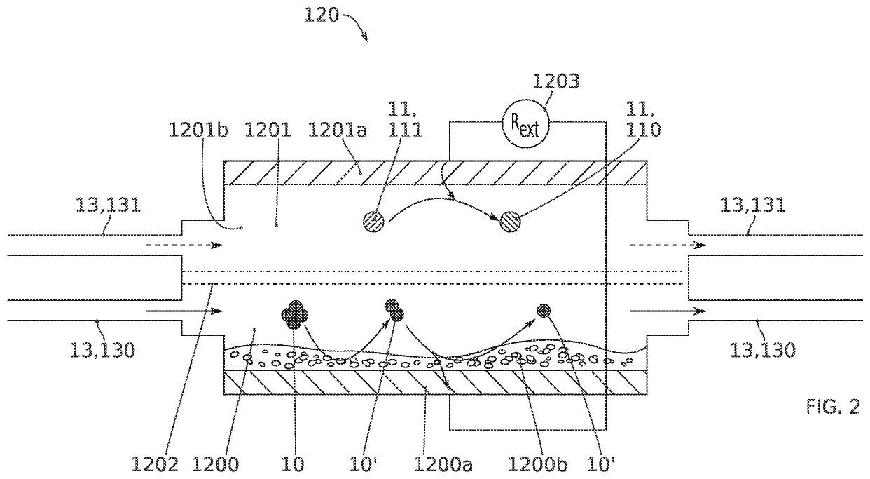

The device 1 for converting biomass 10 to the mediator 11 in its reduced form 110 is now described with reference to FIGS. 1 to 4. First, the operation of a PCM is now described with reference to FIG. 2. Each PCM comprises a first compartment 1200 comprising an anode 1200a and at least one from among fermentative microorganisms 1200b and electroactive microorganisms 1200b. Each PCM further comprises a second compartment 1201 comprising a cathode 1201a and a solution 1201b comprising the mediator 11. The first compartment 1200 and the second compartment 1201 are separated so as to avoid the mixture of their respective solutions, while ensuring an ionic conductivity between the compartments 1200, 1201. In particular, the first compartment 1200 and the second compartment 1201 are separated by a semi-permeable membrane 1202, and more specifically a cationic semi-permeable membrane. Each PCM comprises an external resistance 1203 connecting the cathode 1201a and the anode 1200a. The external resistance 1203 makes it possible to condition at least some of the electric current travelling into the PCM.

As illustrated by FIG. 2, the biomass 10 can be supplied by the fluidic flow line 13 to the first compartment 1200 of a PCM. The biomass 10 can in particular be supplied to the first compartment 1200 by a fluidic anodic line 130. The fermentative microorganisms 1200b in the first compartment 1200 can degrade the biomass 10 into fermentation subproducts, and in particular, into organic acids 10′. In particular, the fermentable sugars of the biomass 10, such as starch and glucose, can be degraded into organic acids such as lactate, butyrate, acetate and formate. The organic acids 10′ can then be consumed by the electroactive microorganisms 1200b, inducing a transfer of electrons from the electroactive microorganisms 1200b to the anode 1200a. The electrons supplied to the anode 1200a can be driven by an electric circuit to the cathode 1201a at the second compartment 1201. The mediator 11 in its oxidised form 111 can thus be reduced at the cathode 1201a. The mediator 11 can be supplied to the PCM by a fluidic cathodic line 131, for example connected to the fluidic connecting line 22.

It is understood that the conversion of the biomass 10 to the mediator 11 in its reduced form 110 makes successive metabolic reactions occur by syntrophy between fermentative microorganisms 1200b and electroactive microorganisms 1200b. In order to optimise this conversion, the device 1 is configured to induce a segregation of the fermentative microorganisms 1200b and electroactive microorganisms 1200b along the assembly 12. The PCM assembly 12 can in particular comprise fermentative microorganisms and electroactive microorganisms, their relative proportions varying between at least two distinct PCMs of the assembly 12, even between each PCM of the assembly 12.

To induce this segregation along the assembly 12, the value of the external resistance 1203 of a PCM 120 is distinct from the value of the external resistance 1203 of at least one other PCM 120 of the assembly 12. More specifically, these resistance values are distinct at a given time t. The value of an external resistance 1203 of a PCM can in particular be distinct from the value of the external resistance 1203 of another consecutive PCM 120 of the assembly 12. For this, at least one PCM 120 can be electrically independent from one or other PCMs of the assembly 12. Preferably, each PCM is electrically independent from other PCMs of the assembly 12. Thus, the external resistance 1203 varies spatially along the assembly 12, in the flow direction of the effluent in the flow line 13. This direction is illustrated in FIG. 1 by the arrows 13. A high external resistance 1203 limits the load transfer in the PCM, and therefore limits the development of electroactive microorganisms 1200b. The development of fermentative microorganisms 1200b is thus favoured by minimising competition with the electroactive microorganisms 1200b. In particular, when the external resistance 1203 is greater than the internal resistance of a PCM, the load transfer is limited between the anode and the electroactive microorganisms 1200b, which limits their development. With the development of fermentative microorganisms 1200b being favoured, the conversion of the biomass 10 to organic acids is optimised.

A low external resistance 1203 favours the load transfer in the PCM, and therefore favours the development of electroactive microorganisms 1200b, at the expense of that of the fermentative microorganisms 1200b. More specifically, when the external resistance 1203 is less than the internal resistance of a PCM, the load transfer is maximised between the anode 1200a and the electroactive microorganisms 1200b, which favours their development. Thus, the conversion of organic acids 10′ to the mediator 11 in its reduced form 110 is optimised.

According to the value of the external resistance 1203 of a PCM, it is understood that one from among the fermentative microorganisms 1200b and the electroactive microorganisms 1200b can be favoured in a PCM. With the value of the external resistance 1203 being spatially variable along the assembly 12, a segregation between fermentative microorganisms 1200b and electroactive microorganisms 1200b is obtained along the assembly 12. Furthermore, the spatial variation of the external resistance 1203 along the assembly 12 enables a treatment of the biomass 10 continuously, relative to a solution wherein the resistance would be varied only temporarily for a PCM, even a PCM assembly.

The assembly 12 can comprise a first PCM 120 group 120a and a second PCM 120 group 120b, following, for example consecutively, in the flow direction of the effluent in the flow line 13. According to this flow direction, the first group 120a is located before the second group 120b. Equally, the first group 120a is located upstream from the second group 120b. The two groups can both be halved from the PCMs 120 of the assembly 12. According to the example illustrated in FIG. 1, when the assembly 12 comprises an odd number n of PCMs 120, the first group 120a can comprise (n+1)/2 first PCM 120 of the assembly 12. The second group 120b can thus comprise following (n−1)/2 PCM 120 of the assembly 12.

The external resistance 1203 of a PCM upstream from the assembly 12, for example of a PCM of the first group 120a, can be chosen so as to favour the fermentative microorganisms 1200b. The external resistance 1203 of a PCM downstream from the assembly 12, for example of the second group 120b, can be chosen so as to favour the electroactive microorganisms 1200b. Thus, the fermentative microorganisms 1200b can degrade the biomass 10 mainly in a first portion upstream from the assembly 12 in the flow direction, to supply organic acids to the electroactive microorganisms 1200b mainly in a second downstream portion of the assembly 12 in this direction. The PCMs 120 downstream from the assembly 12 can be more populated in electroactive microorganisms, using organic acids to reduce the mediator 11. According to an example, the value of the external resistance 1203 of a first PCM 120 of the assembly 12 is less than or equal to the value of the external resistance 1203 of a second PCM 120 of the same assembly 12. In particular, the first PCM 120 can be located before the second PCM 120 in the flow direction. The assembly 12 can exhibit a decreasing gradient of the external resistance 1203 on at least some of the PCMs 120 along the assembly. Thus, the relative proportions between the fermentative microorganisms 1200b and the electroactive microorganisms 1200b develop progressively along the assembly. By progressively, it is understood that the difference between the percentage of fermentative microorganisms 1200b or electroactive microorganisms 1200b relative to the total number of microorganisms, between two consecutive PCMs, is substantially less than 50%, even less than 30%, even less than 20%. The relative proportions between the fermentative microorganisms 1200b and the electroactive microorganisms 1200b in the biofilm can, for example, be deduced from the measurement of the concentrations of fermentation subproducts.

The internal resistance of a PCM corresponds to the sum of the resistances to the load transfers in the reactor, comprising the resistances of the connecting wires, the resistance of the anodic biofilm, the resistance of each of the electrolytes in the anodic compartment and in the cathodic compartment, the resistance of the membrane and the resistance of load transfer to the cathode. For a PCM, when the external resistance is equal to the internal resistance, it is known that the PCM produces the maximum electric power. Each external resistance 1203 can be between Rᵢₙₜ-50 ohm and Rᵢₙₜ+1000 ohm.

According to an example, the value of the external resistance 1203 of a PCM of the first group 120a is between 0.8 Rᵢₙₜ<Rₑₓₜ<1.5 Rᵢₙₜ. The value of the external resistance 1203 of at least one PCM 120 of the first group 120a can be greater than the value of the internal resistance of this PCM 120. For example, this PCM is the first PCM of the assembly 12 in the flow direction.

The value of the external resistance 1203 Rₑₓₜ of a PCM 120 of the second group 120e, even the last PCM of the assembly 12 in the flow direction, can be between Rᵢₙₜ/10<Rₑₓₜ<4 Rᵢₙₜ/5, with Rᵢₙₜ the value of the internal resistance of this PCM 120. In the current solutions, the value of the external resistance 1203 is generally fixed to that of the internal resistance to maximise the electric current circulating in an electric circuit between the anode 1200a and the cathode 1201a. Contrary to these solutions, one objective is to favour the load transfer in a PCM downstream from the assembly 12, by imposing an external resistance 1203 less than the internal resistance of the PCM to optimise the reduction of the mediator 11. This load transfer can be more specifically favoured between the anode 1200a and the cathode 1201a, from the organic material (the biomass and/under the fermentation subproducts) to the mediator. The mediator can exhibit a redox potential greater than that of the organic material. The mediator can exhibit a redox potential of substantially 250 mV relative to the NHE. The difference of the external resistances 1203 between two consecutive PCMs can, for example, be less than 0.1 Rᵢₙₜ. It is noted that this factor can vary, this factor depending in particular on the architecture of the assembly, on the number of PCMs and on the type of effluent.

The external resistance 1203 of at least one PCM 120 of the assembly 12 can be chosen according to the load of the biomass 10. For example, the external resistance 1203 of at least one PCM is chosen according to the COD of the biomass 10 supplied to the conversion device 1. The external resistance 1203 of the other PCMs can further be adapted according to an experimental or theoretical model connecting the load of the biomass 10 supplied and the planned development of this load along the assembly 12. The external resistance 1203 of each PCM of the assembly 12 can be chosen according to the load of the biomass 10 measured in each PCM. Thus, the segregation of the microorganisms 1200b can be adapted to the composition of the biomass 10, even adapted to the development of this composition along the assembly. The treatment of the biomass 10 and its conversion to the mediator 11 in its reduced form 110 are therefore also maximised.

According to an example, the external resistance 1203 of at least one PCM 120 of the assembly 12 can be chosen according to the concentration of acetate measured, for example, at the input of a PCM 120 of the assembly 12. For example, the resistance 1203 can be between R_{int/}/10<Rₑₓₜ<4 Rᵢₙₜ/5, when the concentration of acetate measured is greater than 5 mM. The electroactive microorganisms 1200b mainly use fermentation subproducts, and in particular subproducts of low molar mass such as acetate. The external resistance 1203 can therefore be adapted along the assembly 12 so as to favour the electroactive microorganisms 1200b when the concentration of acetate is sufficient. Thus, the segregation of microorganisms 1200b along the assembly 12 can be adapted to the conversion state of the biomass 10 during its transit in the device 1.

For this, the device 1 can comprise a module for characterising the biomass 10, for example prior to its supply the assembly 12. The module for characterising the biomass 10 can alternatively or complementarily be configured to measure the COD, even the concentration of acetate, the biomass 10 in at least one, even more, even each PCM 120 of the assembly 12.

The load of the biomass 10 can be evaluated from the chemical oxygen demand, abbreviated COD below. The COD is an indicative measurement of the quantity of oxygen which can be consumed by chemical reactions in a solution, and in particular in an aqueous solution, such as an effluent. The chemical reactions can more specifically be reactions of oxidations of oxidable compounds. The COD is generally expressed as mass of oxygen consumed relative to the volume of the solution. The measurement can, for example, be taken according to the standard test method for determining the chemical oxygen demand of water (ASTM D1252-06(2020)). In units of the international system, the COD can be expressed in milligrams per litre (mg/L). Typically, the COD makes it possible to quantify the quantity of oxidable organic material in water. For example, the COD makes it possible to quantify the quantity of oxidable pollutants present in effluents.

The load of the biomass 10 can be characterised by the concentration of volatile organic compounds which can be measured by high performance liquid chromatography (HPLC).

Any other indicator of the load of the biomass 10 can be provided. The online measuring modules of this indicator are known to a person skilled in the art. For example, the total organic carbon can be cited, corresponding to the carbon content linked to the organic substances dissolved and undissolved in a fluid. Moreover, the biochemical oxygen demand can be cited, corresponding to the quantity of biodegradable organic materials, by biochemical oxidation by microorganisms over a given time, typically 5 days. The biochemical oxygen demand only represents the most biodegradable organic compounds, while the COD relates to substantially the whole oxidable organic material.

The arrangement of the cascading PCMs makes it possible to improve the selectivity of the biological functions of each PCM and to maximise the production of the mediator in its reduced form 110 in the cathodic behaviour of the PCMs 120 of the second group 120b, for example in the last PCM 120 of the assembly 12. By cascade, this means that PCMs 120 are fluidically connected at least in series, even further in parallel, even by a combination of fluidic connections in series and in parallel, for example by the fluidic flow line 13. On all of these PCMs 20, the device 1 can comprise, in total, at least ten, even at least twenty PCMs 120. The greater the number of PCMs 120 connected together, the higher the volume of biomass 10 treated by the device 1, in a given time.

The assembly 12 comprises at least three PCMs 120 connected in series, even at least five, even at least ten PCMs in series. Synergically with the feature according to which the PCM assembly exhibits a decreasing gradient of the value of the external resistances 1203 along at least some of the assembly, the greater the number of PCMs connected in series, the more the external resistance 1203 can be adjusted spatially along this part of the assembly 12.

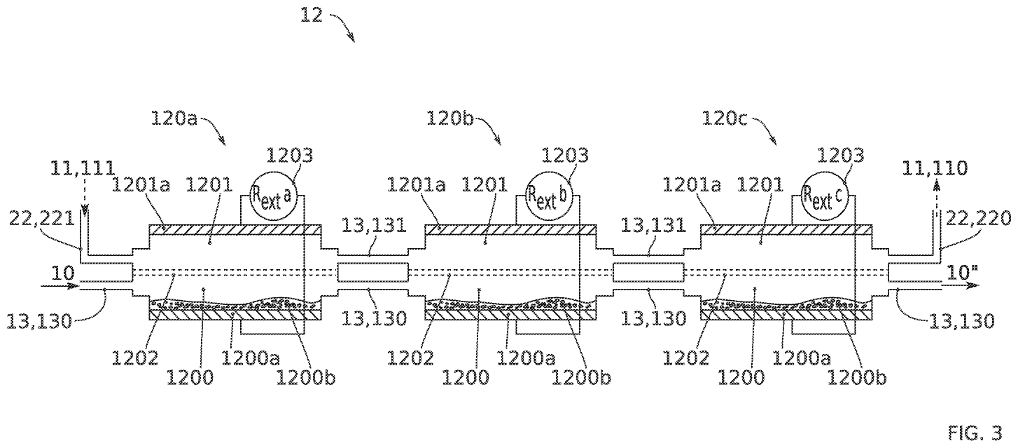

According to the example illustrated in FIG. 3, an assembly 12 can comprise three PCMs 120a, 120b and 120c connected in series. The three PCMs 120a, 120b and 120c respectively exhibit the external resistance values Rₑₓₜa, Rₑₓₜb, and Rₑₓₜc. The values Rₑₓₜa, Rₑₓₜb, and Rₑₓₜc can be chosen such that Rₑₓₜa Rₑₓₜb Rₑₓₜc, with at least one from among Rₑₓₜa, Rₑₓₜb, and Rₑₓₜc distinct from the other values. The values Rₑₓₜa, Rₑₓₜb, and Rₑₓₜc can be chosen such that Rₑₓₜa>Rₑₓₜb>Rₑₓₜc, to form a strictly decreasing gradient.

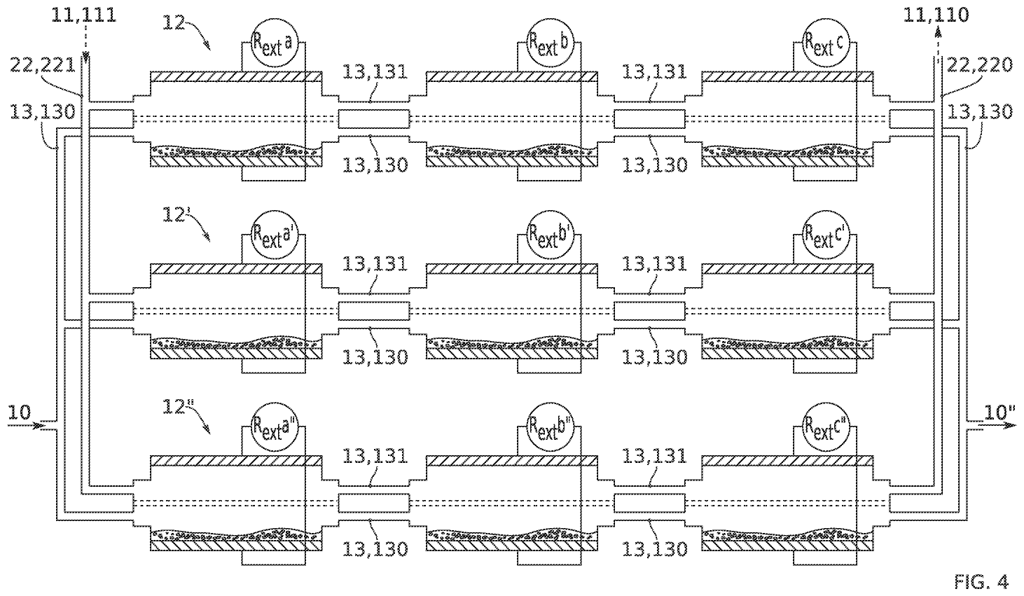

The device 1 can comprise several assemblies 12 connected in parallel by the fluidic flow line 13. Thus, the volume of biomass treated by the device, in a given time, can be increased. According to the example illustrated in FIG. 4, the device 1 can comprise three assemblies 12, 12′ and 12″. According to the example illustrated, each assembly 12 comprises three PCMs connected in series. It can be provided that at least one assembly 12 comprises a number of PCMs of at least one other assembly 12. The values of the external resistances Rₑₓₜa, Rₑₓₜb, and Rₑₓₜc; Rₑₓₜa′, Rₑₓₜb′, and Rₑₓₜc′; Rₑₓₜa″, Rₑₓₜb″, and Rₑₓₜc″ can be different or substantially equal between the assemblies 12, 12′ and 12″. Thus, the values of the external resistances 1203 can be adapted for each assembly 12 and along each assembly 12.

The fluidic flow line 13 can comprise one or more flow conduit(s) making it possible to connect the PCMs 120 of the assembly(ies) 12. For example, as illustrated in FIGS. 3 and 4, the first compartments 1200 of the PCMs can be connected together by an anodic line 130. This line 130 thus comprises portions, each serving to fluidically connect the first compartments 1200 of adjacent PCMs. This anodic line can be connected to the fluidic connecting line 22 to the conversion system 2. According to this example, the second compartments 1201 of the PCMs can be connected together by a cathodic line 131 distinct from the anodic line. This line 131 thus comprises portions, each serving to fluidically connect the second compartments 1200 of adjacent PCMs. The first and second compartments being isolated between them by a semi-permeable membrane, the mediator 11 thus circulates in a fluidic circuit distinct from a fluidic circuit of the biomass 10. The fluidic flow line 13 can comprise as many anodic lines 130 and cathodic lines 131 as assemblies 12, and each anodic line 130 and each cathodic line 131 can comprise as many portions as necessary to connect the PCMs of an assembly, two-by-two, in series.

As illustrated in FIGS. 2 to 4, the fermentative microorganisms 1200b and/or the electroactive microorganisms 1200b can be comprised in a biofilm. By biofilm, this means a community of microorganisms adhering to one another. A biofilm can comprise a protective matrix making it possible to better protect the microorganisms against an external environment, for example against toxic pollutants contained in an effluent. The biofilm can be adherent to the anode 1200a of each PCM.

The fermentative microorganisms 1200b and/or the electroactive microorganisms 1200b can be chosen from among bacteria and fungi. More specifically, the fermentative microorganisms 1200b and/or the electroactive microorganisms 1200b are bacteria. The fermentative microorganisms 1200b and/or the electroactive microorganisms 1200b collected in the purification station can be inoculated to the device 1 prior to its use.

The mediator 11 can exhibit a redox potential barely dependent on variations in concentration of the mediator 11 between its oxidised form 111 and its reduced form 110. The mediator 11 can be buffered by an acid/base pair, and in particular a phosphate buffer comprising, for example, sodium hydrogen phosphate, of chemical formula Na₂HPO₄ and sodium dihydrogen phosphate, of formula NaH₂PO₄. Thus, the pH of the solution comprising the mediator is controlled, which makes it possible to avoid the degradation of the mediator. The mediator 11 can be comprised in a solution of controlled pH at least at the electrolyser 21, and preferably at the electrolyser 21 and of the conversion device 1. By at least one of these features, even synergically between these two features, the redox potential of the mediator is stabilised. The mediator 11 thus exhibits a great reversibility and a great stability for its conversion between its reduced form 110 and its oxidised form 111. The mediator thus stabilised can exhibit a redox potential relatively independent from the variations in concentration of the mediator between its oxidised form and its reduced form. The redox potential can in particular vary by less than +/−20%, even +/−10% of its standard value. The redox potential of the mediator is between 410 mV and 450 mV relative to the NHE, under standard conditions at pH=7 and at a temperature of T=25° C.

According to an example, the mediator 11 can exhibit a redox potential less than that of the O₂/H₂O pair. According to an example, the mediator 11 is a hexacyanoferrate complex. The iron atom of the hexacyanoferrate complex can exhibit an oxidation degree of (III) in its oxidised form 111, and an oxidation degree of (II) in its reduced form 110. The chemical formula of the mediator can be [Fe(CN)₆]³⁻ in its oxidised form 111 and [Fe(CN)₆]⁴⁻ in its reduced form 110. According to this example, the voltage between the cathode 2110 and the anode 2100 of the electrolyser 21 can be greater than or equal to 0.36 V to be greater than or equal to the absolute value of the difference between the redox potential of the H⁺/H₂ pair and the redox potential of the mediator 11. Preferably, the voltage between the cathode 2110 and the anode 2100 of the electrolyser 21 can be substantially equal to 1 V. According to this example, the hexacyanoferrate complex can be comprised in a phosphate buffer solution of pH substantially equal to 7.

Examples of materials which could be used in the system 1 are now given.

For each PCM 120, the anode 1200a and the cathode 1201a can be graphite electrodes. The cationic semi-permeable membrane 1202 separating the first compartment 1200 and the second compartment 1201 of each PCM can be a perfluorinated Naflon®-type membrane.

In case of the presence of a semi-permeable membrane 212 of the electrolyser 21, the anode 2100 can be a nickel foam and the cathode 2110 can be graphite felt containing platinum. The semi-permeable membrane 212 separating the first compartment 210 and the second compartment 211 of the electrolyser 21 can be a cationic semi-permeable membrane.

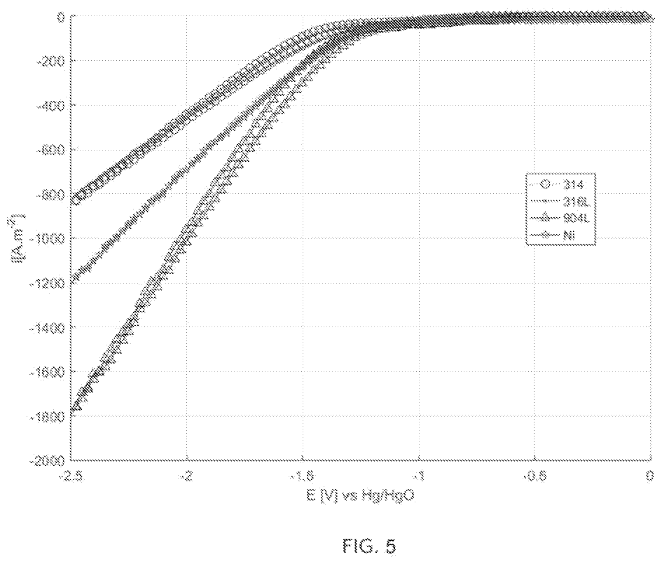

In the case of the electrolyser 21 without a semi-permeable membrane 212, the 904L, 314 and 316L-type nickel or pure nickel alloys and the stainless steels of austenitic phases of 8% to 26% nickel, but also 0% to 7% molybdenum, are potentially constitutive materials of the cathode 2110. More specifically, as is illustrated in FIG. 5, 904L-type stainless steel grades will be preferred to the other abovementioned grades and to nickel, as they offer better performance in terms of releasing hydrogen. The anode 2100 can be with the basis of, even constituted of, a graphite felt, a nickel foam, a DSA®-type commercial electrode. The anode 2100 of the electrolyser 21 is thus preferably of an active surface equal to, as a minimum, double, even triple, the active surface of the cathode 2110.

Indicative compositions of solutions in the different compartments of the reactors are now given. In the anodic compartment 1200 of the PCM 120, the effluent can come from wastewater containing the biomass 10 and the composition of which depends on the activity sector (for example, urban, agribusiness or agricultural). In the cathodic compartment 1201 of the PCM 120 and in the compartment 210 of the electrolyser 21, the mediator 11 can be at a concentration of between 0.1 M and 10 M and stabilised at pH 7 with a phosphate buffer (for example, of composition 0.5 M of Na₂HPO₄ and 0.5 M of NaH₂PO₄). The compartment 211 of the electrolyser 21 can comprise a K₂SO₄ or Na₂SO₄ solution at a concentration of between 0.1 and 1 M and stabilised at pH 7 with a phosphate buffer (for example, of composition 0.5 M of Na₂HPO₄ and 0.5 M of NaH₂PO₄).

The method for converting biomass 10 implementing the conversion device 1, even the conversion system 2, described above, is now detailed. The method comprises a supply of biomass 10, for example of an effluent comprising the biomass 10, to the device 1. The method further comprises an adjustment of the value of the external resistance 1203 of at least one PCM 120, even of each PCM 120, according to the features described above. The method comprises a conversion of the biomass 10 to organic acids 10′ by the fermentative microorganisms 1200b, and a reduction of the mediator 11 of an oxidised form 111 to a reduced form 110.

The adjustment of the value of the external resistance 1203 of at least one PCM 120, even of each PCM 120, can be done according to the load of the biomass 10, or from an indicator of this load. For this, the method can comprise a step of measuring the load of the biomass 10, or from an indicator of this load, prior to its supply to the device 1 and/or during its flow in the device 1. As an example, a low COD value to activate the anodic transfer is substantially equal to 5 mg/L. Alternatively or complementarily, the hydraulic retention time of the effluent in the device 1 can be adapted according to the load of the biomass 10. In particular, the retention time of the effluent can be extended, the lower the load of the biomass 10 is. For this, the conversion device can comprise a pump 14, for example, disposed on the fluidic flow line 14 as illustrated in FIG. 1.

The adjustment of the value of the external resistance 1203 can be done at regular intervals, for example, weekly, even daily. The regular adjustment of the external resistance makes it possible to improve the segregation of the microorganisms 1200b and therefore the production of the mediator 11 in its reduced form 110 when using the device 1. The adjustment of the value of the external resistance 1203 can be synchronised between the PCMs 120 or done independently between the PCMs 120.

The method can further comprise a supply of the mediator 11 in reduced form 110 to the electrolyser 21 and a production of dihydrogen 20 by the electrolyser 21 from the mediator 11 in reduced form 110.

The method can be implemented continuously. The method could be implemented continuously, it is understood that its steps are not necessarily successive. According to an example, the biomass 10 can be supplied continuously to the conversion device 1. According to an alternative or complementary example, the mediator 11 can circulate continuously from the device 1 to the electrolyser 21 and conversely. Synergically, with the feature according to which the mediator 11 exhibits a stabilised potential, the method thus enables a stable and continuous production of dihydrogen.

The method can further comprise an inoculation of the fermentative and/or electroactive microorganisms 1200b to the device 1. For example, a collection of the fermentative and/or electroactive microorganisms 1200b in the purification station can be done. The fermentative and/or electroactive microorganisms 1200b can then be inoculated to the device 1 prior to, or during, its use. When the fermentative and/or electroactive microorganisms 1200b are inoculated to the device 1 prior to its use, the method can comprise a stabilisation step configured such that the device 1 reaches stable performances for the treatment of the effluent and of the reduction of the mediator 11.

The conversion method can further comprise any step making it possible to obtain and/or implement a feature described above of the device 1 and/or of the conversion system 2.

In view of the description above, it clearly appears that the invention proposes a device making it possible to optimise the conversion of the biomass, for example from wastewater, to a reduced mediator. In particular, the invention makes it possible to maximise the conversion of fermentable sugars to the reduced mediator, which can be used for the production of hydrogen at a low cost by an electrolyser.

### REFERENCES

1. Conversion device
10. Biomass
10′. Organic acids
10″. Treated effluent
11. Mediator
110. Reduced form
111. Oxidised form
12. Assembly
12′. Second assembly
12″. Third assembly
120. Microbial fuel cell
120a. First microbial fuel cell
120b. Second microbial fuel cell
120c. Third microbial fuel cell
120d. First group
120e. Second group
1200. First compartment
1200a. Anode
1200b. Microorganisms
1201. Second compartment
1201a. Cathode
1201b. Solution
1202. Semi-permeable membrane
1203. External resistance
13. Fluidic flow line
130. Anodic line
131. Cathodic line
14. Pump
2. Conversion system
20. Dihydrogen
21. Electrolyser
210. First compartment
2100. Anode
211. Second compartment
2110. Cathode
212. Semi-permeable membrane
213. Generator
22. Fluidic connecting line
220. First portion
221. Second portion
23. Pump

1. A device for converting biomass to a redox mediator in a reduced form, comprising an assembly of several microbial fuel cells connected in series by a fluidic flow line, at least two microbial fuel cells each comprising:
a first compartment comprising an anode, fermentative microorganisms and electroactive microorganisms, and
a second compartment comprising a cathode and a solution comprising the redox mediator, the first compartment and the second compartment being separated by a semi-permeable membrane, and
an external resistance connecting the cathode to the anode, wherein a value of the external resistance of one of said at least two microbial fuel cells is distinct from the value of the external resistance of another of said at least two microbial fuel cells, so as to favour, in one of said at least two microbial fuel cells, the fermentative microorganisms relative to the electroactive microorganisms and, in the other of said at least two microbial fuel cells, the electroactive microorganisms relative to the fermentative microorganisms.

2. The device according to claim 1, wherein the value of the external resistance of a first microbial fuel cell of the assembly is less than or equal to the value of the external resistance of a second microbial fuel cell of the same assembly, the first microbial fuel cell being located before the second microbial fuel cell in a flow direction of a fluid in the flow line.

3. The device according to claim 1, wherein the value of the external resistance between at least some of the microbial fuel cells of the assembly is decreasing in a flow direction of a fluid in the flow line.

4. The device according to claim 1, wherein the assembly comprises a first group of microbial fuel cells and a second group of microbial fuel cells following in a flow direction of a fluid in the flow line, and the value of the external resistance Rₑₓₜ of at least one microbial fuel cell of the first group is between 0.8 Rᵢₙₜ<Rₑₓₜ<1.5 Rᵢₙₜ, with Rᵢₙₜ the value of the internal resistance of said cell.

5. The device according to claim 1, wherein the assembly comprising a first group of microbial fuel cells and a second group if microbial fuel cells following in a flow direction of a fluid in the flow line, and the value of the external resistance Rₑₓₜ of a microbial fuel cell of the second group, is between Rᵢₙₜ/10<Rₑₓₜ<4 Rᵢₙₜ/5, with Rᵢₙₜ the value of the internal resistance of said cell.

6. The device according to claim 1, wherein the mediator is buffered by an acid/base pair, such as a dihydrogen phosphate solution.

7. (canceled)

8. The device according to claim 1, the device comprising several assemblies connected in parallel by the fluidic flow line.

9. The device according to claim 1, wherein the mediator has a redox potential in a range of +/−20%, preferably +/−10%, around its value under standard conditions at pH=7 and at a temperature of 25° C.

10. The device according to claim 1, wherein at least one from among the fermentative microorganisms and the electroactive microorganisms comes from an effluent sample from a purification station.

11. A system for converting biomass to dihydrogen comprising:
a device for converting biomass to a redox mediator in a reduced form, according to claim 1, and
an electrolyser configured to produce dihydrogen from the mediator in reduced form.

12. The system according to claim 11, wherein the electrolyser is connected by a fluidic connecting line to the conversion device, the fluidic connecting line being configured to drive, by a first portion, the mediator of the conversion device to the electrolyser and to drive by a second portion, the mediator of the electrolyser to the conversion device.

13. The system according to claim 11, wherein a deviation distance between an anode and a cathode of the electrolyser is greater than 2 mm.

14. A method for converting biomass comprising:
a supply of biomass to a device for converting biomass to a redox mediator in a reduced form, comprising an assembly of several microbial fuel cells connected in series by a fluidic flow line, at least two microbial fuel cells each comprising:
a first compartment comprising an anode, fermentative microorganisms and electroactive microorganisms,
a second compartment comprising a cathode and a solution comprising a redox mediator, the first compartment and the second compartment being separated by a semi-permeable membrane,
an external resistance connecting the cathode and the anode, and
an adjustment of a value of the external resistance of one of said at least two microbial fuel cells such that the value of said external resistance is distinct from the value of the external resistance of the other of said at least two microbial fuel cells, and
a conversion of the biomass at least to organic acids by the fermentative microorganisms, and
a reduction of the mediator of an oxidised form to a reduced form by the electroactive microorganisms,
so as to favour, in one of said at least two microbial fuel cells, the fermentative microorganisms relative to the electroactive microorganisms and, in the other of said at least two microbial fuel cells, the electroactive microorganisms relative to the fermentative microorganisms.

15. The method according to claim 14, wherein the value of the external resistance of at least one microbial fuel cell is adjusted according to a load of the biomass.

16. The method according to claim 14, wherein the value of the external resistance of at least one microbial fuel cell is adjusted so as to be between Rᵢₙₜ/10<Rₑₓₜ<4 Rᵢₙₜ/5 when a concentration of acetate measured at the input of said microbial fuel cell is greater than 5 mM, with Rᵢₙₜ the value of the internal resistance of said cell, the method comprising beforehand to said adjustment, a measurement of the concentration of acetate at the input of said microbial fuel cell.

17. The method according to claim 14, wherein the adjustment of the value of the external resistance of at least one microbial fuel cell is done at regular intervals.

18. The method according to claim 14, further comprising a supply of the mediator in reduced form to an electrolyser and a production of dihydrogen by the electrolyser from the mediator in reduced form.

19. The system according to claim 11, wherein the mediator exhibits a redox potential in a range of +/−20%, preferably +/−10%, around its value under standard conditions at ph=7 and at a temperature of 25° C.

20. The system according to claim 11, wherein the anode of the electrolyser is of an active surface at least equal to double, preferably triple, an active surface of a cathode of the electrolyser.

21. The system according to claim 11, wherein the electrolyser is exempt of a semi-permeable membrane.
